(19) United States
(12) Patent Application Publication
(10) Pub. No.: US 2021/0158260 A1
(43) Pub. Date: May 27, 2021

(54) INTERPRETABLE PEER GROUPING FOR COMPARING KPIs ACROSS NETWORK ENTITIES

(71) Applicant: Cisco Technology, Inc., San Jose, CA (US)

(72) Inventors: Vinay Kumar Kolar, San Jose, CA (US); Jean-Philippe Vasseur, Saint Martin D'uriage (FR); Vikram Kumaran, Cary, NC (US); Grégory Mermoud, Veyra VS (CH); Pierre-Andre Savalle, Rueil-Malmaison (FR)

(73) Assignee: Cisco Technology, Inc.

(21) Appl. No.: 16/693,594

(22) Filed: Nov. 25, 2019

(51) Int. Cl. G06Q 10/06; G06K 9/62; H04L 12/24; H04L 29/08; G06N 20/00

(52) U.S. Cl. CPC G06Q 10/06393; G06K 9/6259; G06N 20/00; H04L 67/1044; H04L 41/16

(57) ABSTRACT

In one embodiment, a network assurance service that monitors a network receives key performance indicators (KPIs) for a plurality of network entities in the network. The service applies clustering to the KPIs, to form KPI clusters. The service designates the network entities associated with the particular KPI cluster as belonging to a peer group, based in part on an assessment that the network entities associated with the particular KPI cluster share one or more attributes. The service uses a machine learning model to identify one of the network entities in the peer group as anomalous among the network entities in the peer group.

### TECHNICAL FIELD

The present disclosure relates generally to computer networks, and, more particularly, to interpretable peer grouping for comparing key performance indicators (KPIs) across network entities.

### BACKGROUND

Networks are large-scale distributed systems governed by complex dynamics and very large number of parameters. In general, network assurance involves applying analytics to captured network information, to assess the health of the network. For example, a network assurance service may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

Generally speaking, key performance indicators (KPIs) in a network are measurements that quantify how well a specific entity in the network is performing. For example, in the case of a wireless access point (AP), the percentage of radio errors, the percentage of successful associations, client received signal strength indicators (RSSIs), etc. are all KPIs that can indicate how well the AP is performing in the network.

From a network assurance perspective, comparing KPIs across different network entities can help to better assess the performance of a network entity. Unfortunately, though, many networks are heterogenous and the KPIs of their entities vary widely. Thus, comparing the KPIs of one network entity to those of another may offer little to no useful insights regarding the network.

### BRIEF DESCRIPTION OF THE DRAWINGS

FIGS. 1A-1B illustrate an example communication network;

FIG. 2 illustrates an example network device/node;

FIG. 3 illustrates an example network assurance system;

FIG. 4 illustrates an example architecture for assessing key performance indicators (KPIs) in a network;

FIG. 5 illustrates an example plot showing KPI clusters across network entities;

FIG. 6 illustrates an example plot of tunnel latencies across network entity peer groups; and

FIG. 7 illustrates an example simplified procedure for comparing KPIs across network entities.

### DESCRIPTION OF EXAMPLE EMBODIMENTS

### Overview

According to one or more embodiments of the disclosure, a network assurance service that monitors a network receives key performance indicators (KPIs) for a plurality of network entities in the network. The service applies clustering to the KPIs, to form KPI clusters. The service designates the network entities associated with the particular KPI cluster as belonging to a peer group, based in part on an assessment that the network entities associated with the particular KPI cluster share one or more attributes. The service uses a machine learning model to identify one of the network entities in the peer group as anomalous among the network entities in the peer group.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

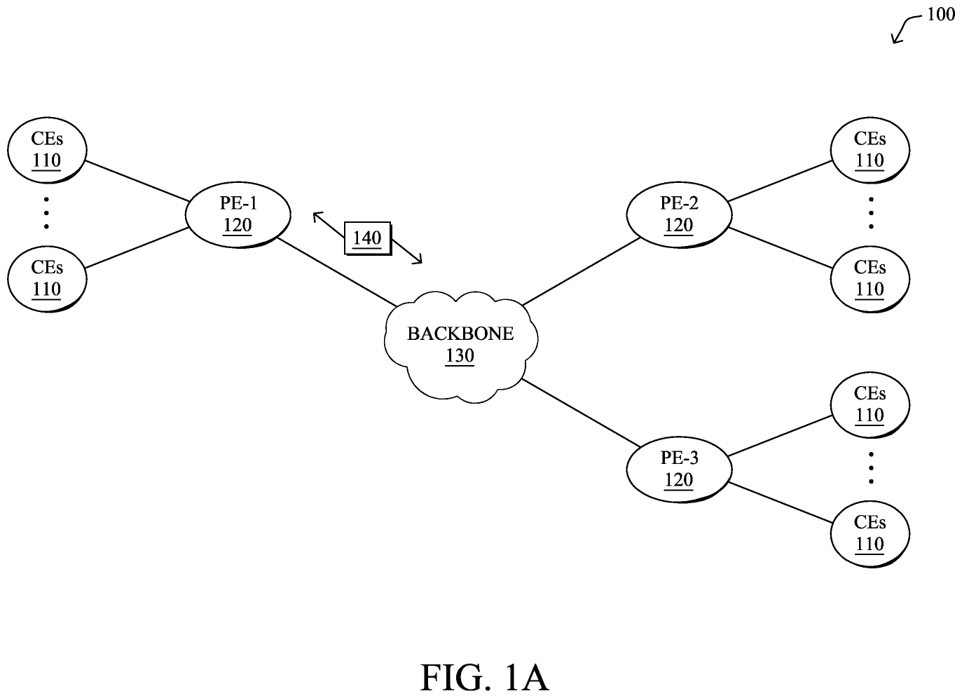

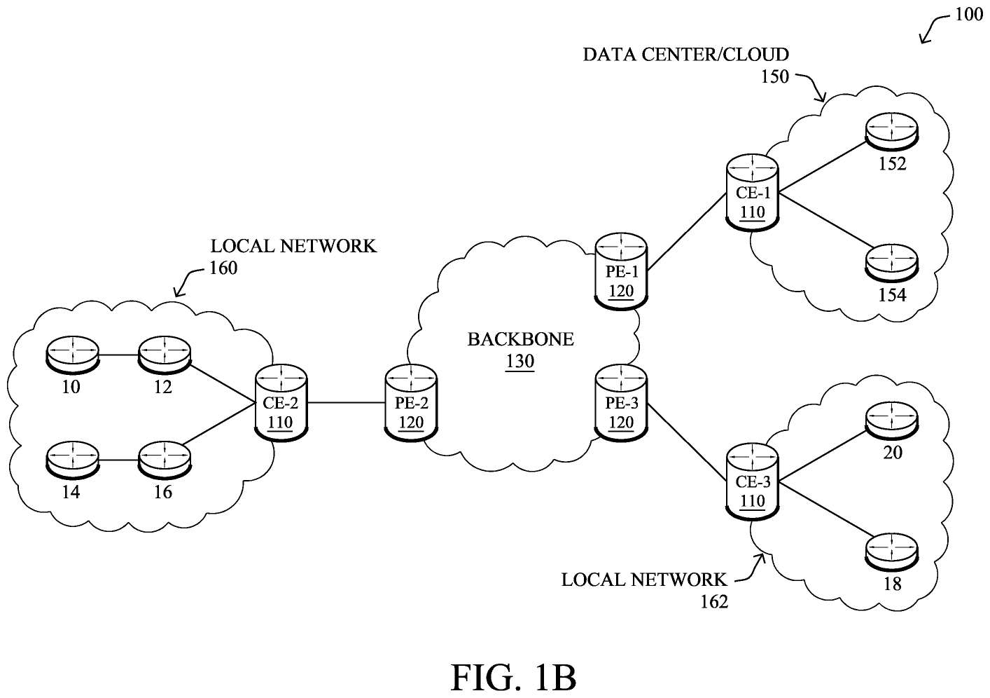

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected 1o to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network 1o topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal 1o changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

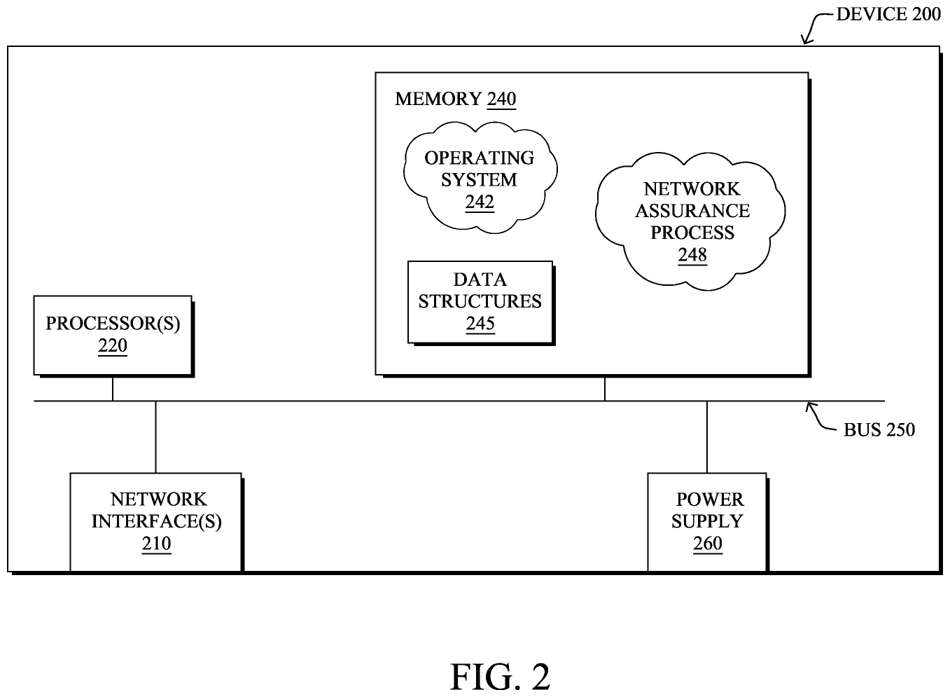

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by 1o the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance service. To evaluate a rule regarding these conditions, the network assurance service may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and/or to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

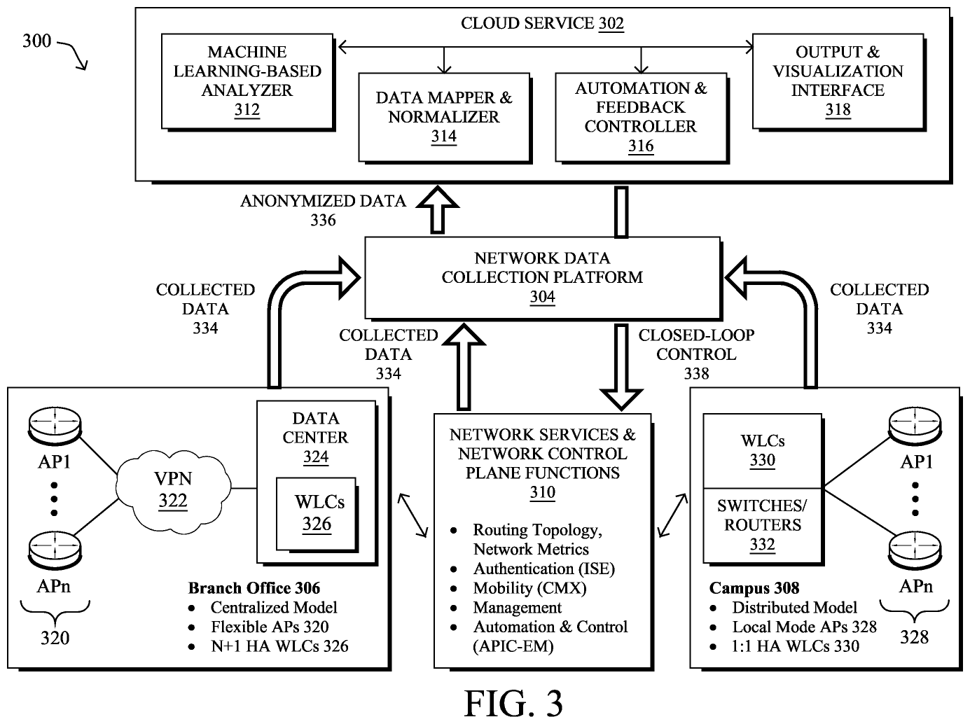

FIG. 3 illustrates an example network assurance system 300, according to various embodiments. As shown, at the core of network assurance system 300 may be a cloud-based network assurance service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point API through nth access point, APn) through which endpoint nodes may connect. Access points 320 may, in turn, be in communication with any number of wireless LAN controllers (WLCs) 326 (e.g., supervisory devices that provide control over APs) located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point API through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning (ML)-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc.). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

As noted above, a network assurance system/service may leverage machine learning to detect anomalies and outlier behavior among a collection of networking entities (e.g., APs, AP controllers, switches, routers, tunnels, links, etc.) based on any number of observed measurements/key performance indicators (KPIs). These KPIs may include, for example, metrics like utilization, client count, throughput, traffic, loss, latency, jitter, or any other measurement from a network that can indicate entity performance.

To assess whether a network entity is performing correctly, a network assurance service, such as service 302, may apply an anomaly detector to one or more KPIs of the network entity. To this end, comparing the KPIs of multiple network entities can help to better assess whether the performance of a particular entity is truly anomaly. Unfortunately, though, comparing KPIs across network entities often provides little insight, as many networks are heterogenous and the KPIs of their entities vary widely.

To ensure that the KPIs compared across network entities are truly comparable, the network assurance system/service may limit the comparison to network entities that belong to the same peer group. In general, a peer group is a group of network entities that are considered similar in some way. For example, a peer group may comprise network entities that are geographically related (e.g., located in the same building, city, etc.), share the same model of hardware, have the same or similar software configurations, or the like.

Peer groups are typically defined manually by network administrators and experts based on heuristics and/or their own experiences. However, there is no set definition of what a ‘peer’ entity truly is and each use case may have its own definition. For example, an administrator may want to compare the KPIs of tunnels in a software-defined WAN (SD-WAN), such as loss, latency, and jitter measurements, across peer tunnels that are grouped based on geo-distances, traffic observed on links, their reliabilities, and/or service providers to which the tunnels am attached.

From a network assurance standpoint, the definition of peer groups is critical to the proper analysis of the network. Indeed, the application of anomaly detection and machine learning to peer groups requires that the entities in a peer group are indeed peers. If they are not, this can alter what the model considers to be ‘normal’ behavior, leading to false positives and false alarms or, conversely, false negatives and undetected issues.

### Interpretable Peer Grouping for Comparing KPIs Across Network Entities

The techniques herein allow for the creation of interpretable peer groups of network entities that allow a network assurance system to compare KPIs across the entities. In some aspects, a scoring mechanism is introduced herein that quantifies the ‘quality’ of a peer group with respect to a primary KPI. In further aspects, the techniques herein also allow non-interpretable KPI clusters to be mapped to interpretable attributes. In further aspects, the techniques herein are also able to detect changes in a peer group and dynamically recompute peer groups as needed.

Specifically, according to one or more embodiments of the disclosure as described in detail below, a network assurance service that monitors a network receives key performance indicators (KPIs) for a plurality of network entities in the network. The service applies clustering to the KPIs, to form KPI clusters. The service designates the network entities associated with the particular KPI cluster as belonging to a peer group, based in part on an assessment that the network entities associated with the particular KPI cluster share one or more attributes. The service uses a machine learning model to identify one of the network entities in the peer group as anomalous among the network entities in the peer group.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

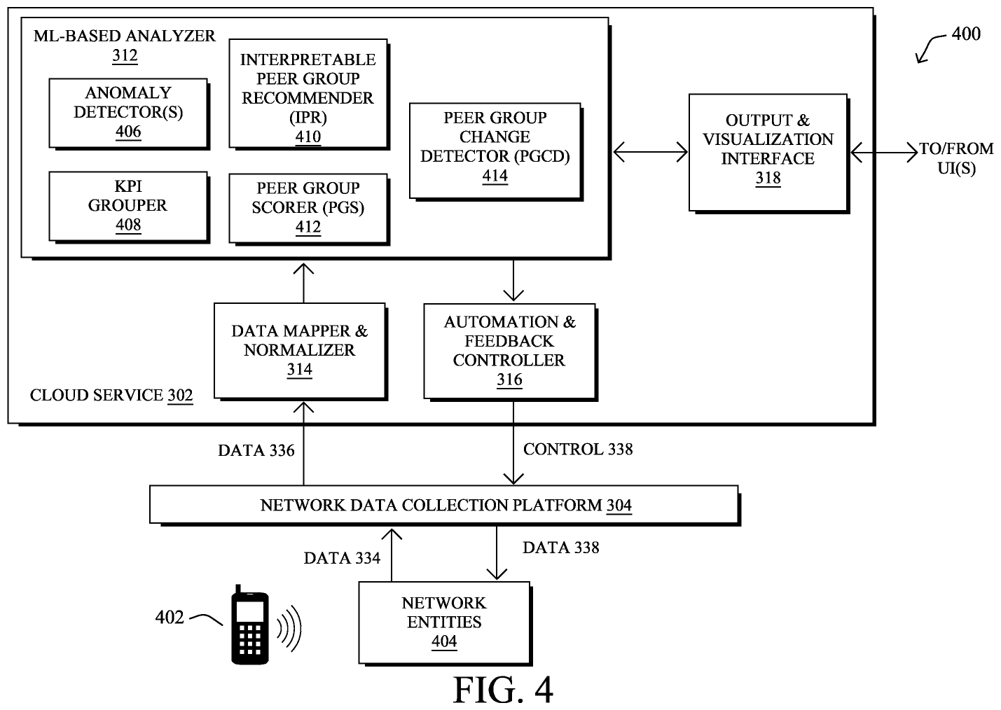

Operationally, FIG. 4 illustrates an example architecture 400 for performing KPI trajectory-driven outlier/anomaly detection in a network assurance service, according to various embodiments. At the core of architecture 400 may be the following components: one or more anomaly detectors 406 or other machine learning models, a KPI grouper 408, an interpretable peer group recommender (IPR) 410, a peer group scorer (PGS) 412, and/or a peer group change detector (PGCD) 414. In some implementations, the components 406-414 of architecture 400 may be implemented within a network assurance system, such as system 300 shown in FIG. 3. Accordingly, the components 406-414 of architecture 400 shown may be implemented as part of cloud service 302 (e.g., as part of machine learning-based analyzer 312 and/or output and visualization interface 318), as part of network data collection platform 304, and/or on one or more network elements/entities 404 that communicate with one or more client devices 402 within the monitored network itself. Further, these components 406-414 may be implemented in a distributed manner or implemented as its own stand-alone service, either as part of the local network under observation or as a remote service. In addition, the functionalities of the components of architecture 400 may be combined, omitted, or implemented as part of other processes, as desired.

During operation, service 302 may receive telemetry data from the monitored network (e.g., anonymized data 336 and/or data 334) and, in turn, assess the data using one or more anomaly detectors 406. At the core of each anomaly detector 406 may be a corresponding anomaly detection model, such as an unsupervised learning-based model. As noted, such a model may compare one or more KPIs indicated by data 334/336 for a particular network entity 404 to those of peer network entities.

When an anomaly detector 406 detects a network anomaly, output and visualization interface 318 may send an anomaly detection alert to a user interface (UI) for review by a subject matter expert (SME), network administrator, or other user. Notably, an anomaly detector 406 may assess any number of different network behaviors captured by the telemetry data (e.g., number of wireless onboarding failures, onboarding times, DHCP failures, etc.) and, if the observed behavior differs from the modeled behavior by a threshold amount, the anomaly detector 406 may report the anomaly to the user interface via network anomaly, output and visualization interface 318.

To ensure that anomaly detector(s) 406 assess the KPIs of peer network entities, architecture 400 may include KPI group 408, which is responsible for evaluating how different KPIs are distributed across network entities 404 and using that information to group entities that have similar KPIs.

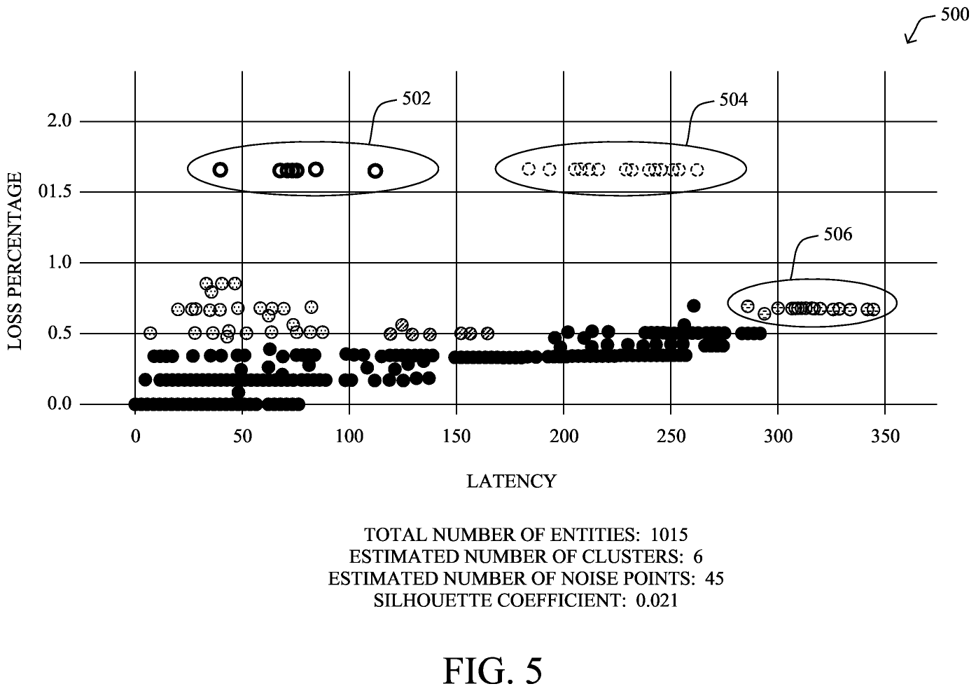

In one embodiment. KPI grouper 408 may cluster the KPI values observed across network entities 404 from any number of networks. In turn, KPI group may identify sets of ‘tight’ clusters (i.e., clusters of entities that exhibit very similar KPIs). For example, FIG. 5 illustrates an example plot 500 of the loss and latency KPIs for different network tunnels. These KPIs were then clustered using a density-based clustering algorithm. DBSCAN. As would be appreciated, though, other clustering approaches can also be used to cluster network entities based on their KPIs.

As shown in plot 500, a total of six clusters were formed from a total of 1,015 network entities. Some of these clusters exhibit good separation between KPI values (loss and latency). Notably, each cluster uses one KPI value (e.g., mean loss over a defined period of time, such as one month). However, the loss may vary over smaller time ranges. To include these, other statistical metrics, such as variance, can also be added as features while clustering.

As a result of the clustering, the networking entities in each cluster will exhibit similar KPI behaviors. Cluster 502, for example, comprises network entities (e.g., tunnels) that exhibit high loss but low latency. Cluster 504, in contrast, comprises network entities with both high loss and high latency. Cluster 506, meanwhile, exhibits low loss but very high latency.

Referring again to FIG. 4, in another embodiment. KPI grouper 408 may first group all the reported KPIs using clustering, as part of a first iteration. If the resulting clusters are not tight, this means that KPI grouper 408 cannot find any clusters with low variance between their KPIs. In such a case, as part of a subsequent pass. KPI grouper 408 may break the KPIs into individual KPIs and create new clusters for each of these KPIs. Note that in such a case, it is not possible to identify peer groups where all KPIs (e.g., loss, latency, and jitter, etc.) are similar. However, there may be entities 404 that can still be clustered by their individual KPIs (e.g., entities that exhibit similar losses, etc.).

In a further embodiment, KPI grouper 408 may use multiple dimensions while clustering network entities 404 by KPI so as to compute a peer group using multiple KPIs. Indeed, in many use cases the nature of the network entities 404 is characterized by more than one dimension, even though an anomaly detector 406 may be applied to any KPI. Said differently, the KPI(s) used by KPI grouper 408 to form entity peer groups is orthogonal to the KPI(s) of interest for applying machine learning.

Another potential component of architecture 400 is interpretable peer group recommender (IPR) 410, which is responsible for recommending peer groups that have interpretable meaning to the end-user, in further embodiments. Indeed, simply clustering KPIs and labeling them as “peers” may be meaningless to an end user, such as a network administrator. For example, if SD-WAN tunnels located in the United States, Europe, and Korea are all grouped together, e.g., due to the tunnels all exhibiting low latency and loss KPI values, then the network administrator may not be able to make sense of the grouping.

In one embodiment. IPR 410 may gather a set of interpretable attributes that can be used for peer grouping for a given use case (e.g., using an UI or configuration file for the use case). Note that the interpretable features may be KPIs themselves (e.g., loss, latency, jitter in SD-WAN tunnels, etc.) and/or other attributes (e.g., cities, distance between edge routers, service providers, etc.).

Let C=[C₁, C₂, . . . ] represent the initial set of clusters sent by KPI grouper 408 to IPR 410. In such a case. IPR 410 will then tag each cluster Cᵢ with interpretable attributes. For example, for each Cᵢ, IPR 410 may create attributes for a network entity 404 such as {continent_pair: “US_EU”, link_type: “hub_spoke”}. IPR 410 may then perform any or all of the following steps to identify strong interpretable clusters:
For each cluster and attribute combination (Cᵢ, aⱼ) compute the purity of that cluster with respect to the attribute p(Cᵢ, aⱼ). This can be done by first computing the p(Cᵢ, aⱼ=x)=(num points with value of ai=x)/(total num points in Cᵢ) for every possible value of aⱼ, and taking the max(p(Cᵢ, aⱼ=x)) for all values of x, where aᵢ is a categorical attribute. Such a metric measures how ‘pure’ the cluster is with respect to taking one value of an attribute. For example, p(Cᵢ, aⱼ)=1 implies that all the points in the cluster Cᵢ, takes only one value of aⱼ. (say aⱼ=some x)
In the second step, IPR 410 may only consider the clusters that have high purity, say p(Cᵢ, aⱼ)>threshold, for at least one attribute aⱼ. These are the clusters where there is a strong clustering of KPI values by KPI grouper 408 and where there is a strong interpretation. For example, one cluster C₁ might group all tunnels that belong to {continent_pair “US_EU”, link_type: “hub_spoke” } since it had high purity for p(C₁, continent_pair=“US_EU”) and p(C₁, link_type=“hub_spoke”), where a cluster C₂ might be {continent_pair: “US_EU”, link_type: “mesh”}, e.g., p(C₂, continent_pair=“US_EU”) and p(C₂, link_type=“mesh”).

To illustrate the operation of IPR 410, consider again plot 500 in FIG. 5. Assume that the network entities associated with cluster 504 comprise tunnels that originate in either Europe or North America and terminate in Asia. Similarly, assume that the network entities associated with cluster 506 comprise tunnels that originate in Europe and terminate in Asia. In such cases. IPR 410 may determine that cluster 506 is ‘pure’ and can be considered an interpretable peer group, as all of its associated network entities share the same geographic characteristics. Conversely, IPR 410 may determine that cluster 504 has a lower purity, as its entities are located in Europe OR North America.

Referring again to FIG. 4, in other embodiments, IPR 410 may quantify the effectiveness of the clustering by KPI grouper 408 based on an index such as a Dunn-Index, Davis-Bouldin index. Silhouette score, or the like. Here, such an index may quantify how much variance there is within a given cluster compared to the variances of the other clusters or peer groups.

A further potential component of architecture 400 is peer group scorer (PS) 412, which is responsible for scoring ‘good’ peer groups for a given use case. One definition of ‘good’ may be whether the primary KPI values used in the use case are typically in the same range.

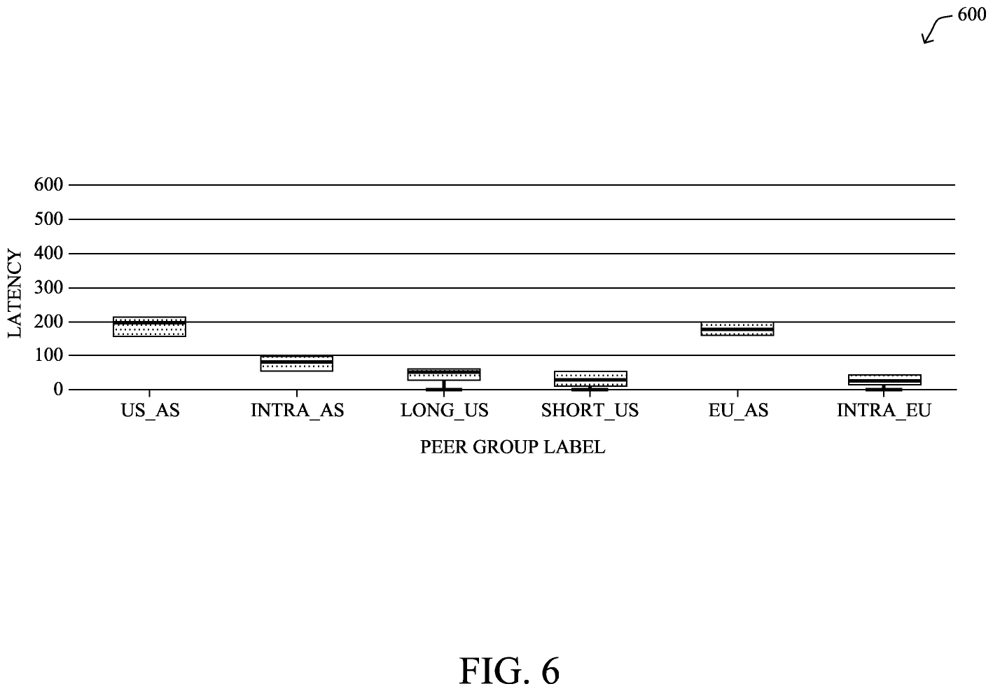

In one embodiment, PGS 412 will take as input the clusters for peer grouping from IPR 410. In turn, PGS 412 then evaluates the variance of all the KPIs between entities within each group. In one SD-WAN example, the peer groups are provided by the network operator based on the continent and country of the tunnel end points. For example, FIG. 6 illustrates a plot 600 of the tunnel latency values across a given set of peer groups that may be identified by KPI grouper 408 and IPR 410.

As shown, each box in plot 600 represents the distribution of latency values for the network entities in that peer group. From plot 600, it can be seen that the tunnels in the US_AS peer group (e.g., tunnels between the United States and Asia) have a much higher latency than those in the intra_EU peer group (e.g., tunnels that both begin and end in Europe. It can also be seen that the US_AS peer group consistently demonstrates a latency around 200 ms. If there is a large variance of the KPI(s) for one or more peer group, then PGS 412 may discard that peer group. In another embodiment, a user (via the UI) may iteratively promote peer group attributes, to provide better rules until low-variance KPIs are observed.

Referring yet again to FIG. 4, another potential component of architecture 400 is peer group change detector (PGCD) 414 that is responsible for detecting when a peer group is no longer valid. In one embodiment, service 302 may maintain the peer groups finally decided by PGS 412 in a peer group database. In turn, PGCD 414 may monitor the KPIs for a given use case, and regularly monitor the clusters by calling KPI grouper 408. If the clustering has changed significantly, or if network entities move between groups, then PGCD 414 may trigger IPR 410 and PGS 412 to recompute the peer groups so that their KPIs can be assessed by anomaly detector(s) 406 and/or other machine learning models of analyzer 312.

PGCD 414 may detect cluster changes using any number of suitable approaches. In one embodiment, PGCD 414 may map each cluster C₁ in the “new” clusters from KPI grouper 408 to the nearest cluster in the set of “old” clusters in the peer group database. PGCD 414 can find this nearest cluster, for example, based on an appropriate metric such as the Jaccard distance. The Jaccard distance, in this context, measures the number of points that belong to both the old and the new cluster, divided by the number of points in the union of the two clusters. If the Jaccard distance is small for most of the clusters which were used for interpretability, it means that there is no large overlap between the old and new clusters are observed and, hence, the clustering has significantly changed. In such cases, PGCD 414 can restart the entire peer group formation process by calling IPR 410 and PGS 412 and storing the new peer groups in the peer group database of service 302. PGCD 414 may also send an alert to the UI and/or to anomaly detertor(s) 406 indicative of the peer group changes, so that the new peer groups can be analyzed.

In another embodiment, if several entities jump between clusters. PGCD 414 may determine that these changes are not significant enough to recompute the peer groups (e.g., based on the number of entities that changed clusters, etc.). In such a case, PGCD 414 may simply flag or blacklist those entities that changed clusters.

In one embodiment, if the entities are blacklisted by PGCD 414, their analysis by 1o anomaly detector(s) 406, or any anomalies that result, may be suppressed, since they are expected to have different behaviors than their potential peers. For example, consider the use case where SD-WAN tunnels are grouped to detect outliers with regards to average throughput. In other words, anomaly detector(s) 406 may determine whether the throughput of a tunnel in a particular peer group tends to diverge from the throughput of the other tunnels in the group. Because of the clustering strategy, the tunnel jumping between clusters may result in a higher rate of anomalies raised by anomaly detector(s) 406. In such a case, the anomalies associated with the tunnel can be ignored (e.g., the tunnel may be flagged as anomalous because of a deficiency of the clustering strategy) and/or used by PGCD 414 to trigger a recomputation of the clusters by KPI grouper 408.

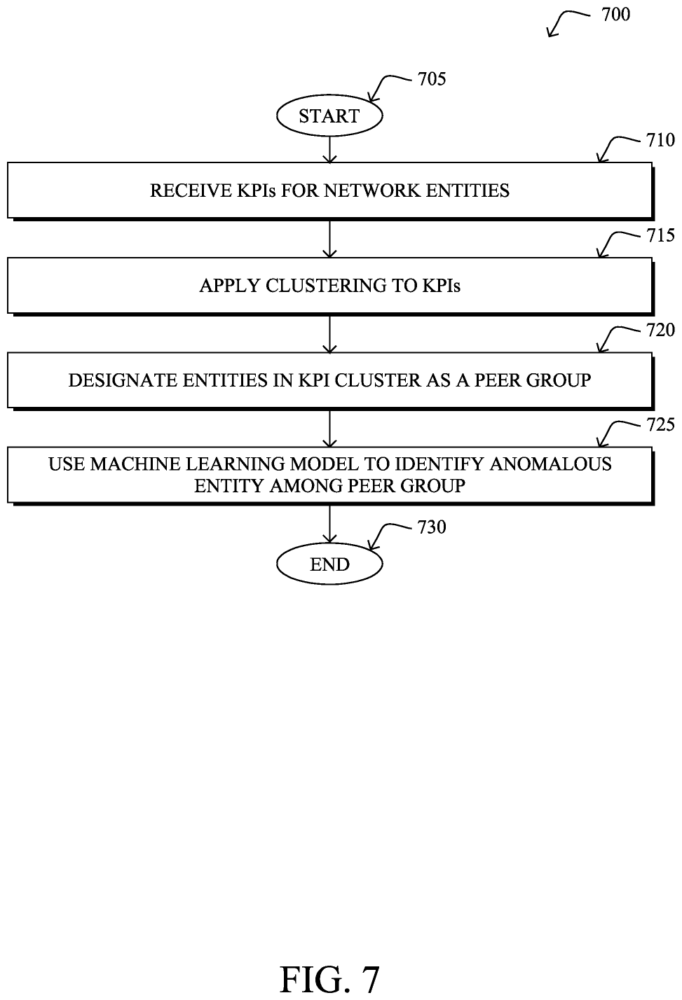

FIG. 7 illustrates an example simplified procedure for comparing KPIs across network entities, in accordance with one or more embodiments described herein. For example, a non-generic, specifically configured device (e.g., device 200) may perform procedure 700 by executing stored instructions (e.g., process 248), to provide a network assurance service to a monitored network. The procedure 700 may start at step 705, and continues to step 710, where, as described in greater detail above, the network assurance service may receive key performance indicators (KPIs) for a plurality of network entities. Such KPIs may include, for example, utilization, client count, throughput, traffic, delays, loss, jitter, etc. The network entities may generally be any device or other entity that supports communications in the network such as APs, WLCs or other AP controllers, switches, routers, tunnels, and the like.

At step 715, as detailed above, the service may apply clustering to the KPIs, to form KPI clusters. For example, the service may apply DBSCAN or another suitable clustering approach to the received KPIs. As a result, the service will essentially group the network entities such that the entities within a given cluster exhibit at least some degree of similarity with respect to their KPIs.

At step 720, the service may designate the network entities associated with the particular KPI cluster as belonging to a peer group, as described in greater detail above. In various embodiments, this may be based in part on an assessment that the network entities associated with the particular KPI cluster share one or more attributes. For example, the service may designate a given KPI cluster as being a peer group if the network entities of the cluster share the same location (e.g., the same building, geographic location, etc.), the same hardware model, or the like. In further embodiments, the service may also base this designation on a score that quantifies how often the KPIs in the cluster are within the same range. Indeed, it may be counter productive to include network entities in a peer group, if the KPIs of those entities change over time such that they would no longer be in that cluster. In another embodiment, the service may also base this designation on a quality metric for the cluster, such as a Dunn-Index, a Davis Bouldin index, a Silhouette score, or the like.

At step 725, as detailed above, the service may use a machine learning model to identify one of the network entities in the peer group as anomalous among the network entities in the peer group. For example, the service may apply a machine learning-based anomaly detector to the KPIs of the peer network entities, to determine whether any of the entities are behaving abnormally relative to its peers. If so, the service may initiate corrective measures, such as redirecting traffic in the network, generating an alert, etc. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce an approach that facilitates the formation of peer groups of network entities, thereby allowing a network assurance service to better identify abnormally-behaving entities in a network. By comparing 1o entities that typically exhibit not only similar KPIs, but also share one or more interpretable attributes (e.g., all tunnels originate in Europe, all APs are of the same model number, etc.), the service is able to provide greater context to an administrator regarding an abnormally-behaving entity.

While there have been shown and described illustrative embodiments that provide for forming network entity peer groups based on the KPIs of the entities, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a network assurance service that monitors a network, key performance indicators (KPIs) for a plurality of network entities in the network;
applying, by the network assurance service, clustering to the KPIs, to form KPI clusters;
designating, by the network assurance service, the network entities associated with the particular KPI cluster as belonging to a peer group, based in part on an assessment that the network entities associated with the particular KPI cluster share one or more attributes; and
using, by the network assurance service, a machine learning model to identify one of the network entities in the peer group as anomalous among the network entities in the peer group.

2. The method as in claim 1, wherein the network entities comprise at least one of: routers, switches, or wireless access points.

3. The method as in claim 1, wherein the network entities comprise tunnels.

4. The method as in claim 1, wherein designating the network entities associated with the particular KPI cluster as belonging to a peer group comprises:
computing a score that quantifies how often the KPIs in the particular KPI cluster are within the same range.

5. The method as in claim 1, further comprising:
detecting, by the network assurance service, a change in the network entities associated with the particular KPI cluster; and
recomputing, by the network assurance service, the peer group, based on the detected change.

6. The method as in claim 5, wherein the change is detected based on a Jaccard distance.

7. The method as in claim 1, wherein the one or more attributes are indicative of at least one of: a common location of the network entities or a common model of hardware of the network entities.

8. The method as in claim 1, wherein the network entities are designated as belonging to the peer group based in part on a Dunn-Index, Davis-Bouldin index, or Silhouette score associated with the particular KPI cluster.

9. The method as in claim 1, wherein the plurality of KPIs are indicative of at least one of: utilization, client count, throughput, traffic, loss, latency, or jitter.

10. An apparatus, comprising:
one or more network interfaces;
a processor coupled to the network interfaces and configured to execute one or more processes; and
a memory configured to store a process executable by the processor, the process when executed configured to:
receive key performance indicators (KPIs) for a plurality of network entities in a network;
apply to the KPIs, to form KPI clusters;
designate the network entities associated with the particular KPI cluster as belonging to a peer group, based in part on an assessment that the network entities associated with the particular KPI cluster share one or more attributes; and
use a machine learning model to identify one of the network entities in the peer group as anomalous among the network entities in the peer group.

11. The apparatus as in claim 10, wherein the network entities comprise at least one of: routers, switches, or wireless access points.

12. The apparatus as in claim 10, wherein the network entities comprise tunnels.

13. The apparatus as in claim 10, wherein the apparatus designates the network entities associated with the particular KPI cluster as belonging to a peer group by:
computing a score that quantifies how often the KPIs in the particular KPI cluster are within the same range.

14. The apparatus as in claim 10, wherein the process when executed is further configured to:
detect a change in the network entities associated with the particular KPI cluster; and
recompute the peer group, based on the detected change.

15. The apparatus as in claim 14, wherein the change is detected based on a Jaccard distance.

16. The apparatus as in claim 10, wherein the one or more attributes are indicative of at least one of: a common location of the network entities or a common model of hardware of the network entities.

17. The apparatus as in claim 10, wherein the network entities are designated as belonging to the peer group based in part on a Dunn-Index, Davis-Bouldin index, or Silhouette score associated with the particular KPI cluster.

18. The apparatus as in claim 10, wherein the plurality of KPIs are indicative of at least one of: utilization, client count, throughput, traffic, loss, latency, or jitter.

19. A tangible, non-transitory, computer-readable medium storing program instructions that cause a network assurance service that monitors a network to execute a process comprising:
receiving, at the network assurance service, key performance indicators (KPIs) for a plurality of network entities in the network;
applying, by the network assurance service, clustering to the KPIs, to form KPI clusters;
designating, by the network assurance service, the network entities associated with the particular KPI cluster as belonging to a peer group, based in part on an assessment that the network entities associated with the particular KPI cluster share one or more attributes; and
using, by the network assurance service, a machine learning model to identify one of the network entities in the peer group as anomalous among the network entities in the peer group.

20. The computer-readable medium as in claim 19, wherein the process further comprises:
detecting, by the network assurance service, a change in the network entities associated with the particular KPI cluster; and
recomputing, by the network assurance service, the peer group, based on the detected change.
